(19) United States
(12) Patent Application Publication
(10) Pub. No.: US 2022/0038782 A1
(43) Pub. Date: Feb. 3, 2022

(54) MOBILE SPORTS APPLICATION FOR GAME-TIME SIDELINE AUDIO

(71) Applicant: Marlon Adolphus Scarbrough, JR., Pelham, AL (US)

(72) Inventor: Marlon Adolphus Scarbrough, JR., Pelham, AL (US)

(21) Appl. No.: 16/945,330

(22) Filed: Jul. 31, 2020

(51) Int. Cl. H04N 21/4722; H04N 21/433; H04N 21/431; G06F 3/0482; H04L 29/06

(52) U.S. Cl. CPC H04N 21/4722; H04N 21/433; G06F 3/0483; G06F 3/0482; H04L 65/601; H04N 21/4312

(57) ABSTRACT

The mobile sports application for game-time sideline audio allows a user to hear the game day action just as if the user was sitting in the front row or on the field, so they can feel like they're in the action, not just watching it. The app allows users to automatically push games and clips from a user's favorite teams to the user's home screen, view clips and highlights of favorite players and teams, then save favorite moments to re-watch later, archive games and clips for later viewing, follow specific teams and players, view the whole league's schedule in one place, with customizable reminders for game dates and start times so users never miss a game, customize feeds and a notifications page to keep users up-to-date with their favorite teams and players, and toggle on and of a ticker feature showing scores from other live games, while streaming games.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of mobile applications (apps) and more specifically relates to mobile sports apps for game-time sideline audio.

### 2. Description of the Related Art

A mobile app is a computer program designed to run on smartphones, tablet computers and other mobile devices. Mobile apps were originally offered for general productivity and information retrieval, including email, calendar, contacts, and stock market and weather information. The explosion in number and variety of apps made discovery a challenge, which in turn led to the creation of a wide range of review, recommendation, and curation sources, including blogs, magazines, and dedicated online app-discovery services. Many new apps are desirable to provide convenient solutions to the users that do exactly what the user wants the app to do.

In order to achieve success in the marketplace, however, any potential invention must meet two basic requirements. First, there must be a demonstrated need or desire among a group of people, a need or desire that the invention will satisfy. Second, a sufficient number of people must share that need or desire. To be successful, it isn't necessary that an invention be a “world-changer”—it is only necessary that the invention meets a need or desire that a sufficient number of consumers have, at a price they are willing to pay.

Generally speaking, the current apps allowing users to watch professional sports games require the user to subscribed to a streaming service and watch the game with the audio commentary provided, or without audio commentary if none is provided. Even watching the games on TV results in missing out on the sounds of the game, as all you can hear is the recorded commentary. This is a problem because sometimes the best part of the game is trash talking between players, yelling at the ref, bone-crunching hits and off-the-cuff outbursts. However, unless you're sitting in the stands, you'll miss it all.

Various attempts have been made to solve the problems that may be found in the related art but have thus far been unsuccessful. A need exists for a reliable the Sidelines Audio App mobile application to avoid the above-mentioned problems.

### BRIEF SUMMARY OF THE INVENTION

In view of the foregoing disadvantages inherent in the known art, the present invention provides a novel mobile app. The general purpose of the present invention, which will be described subsequently in greater detail, is to provide Sidelines Audio App mobile application, a simple, user friendly application that lets you hear the game day action just as if you were sitting in the front row or on the field.

The mobile sports application for game-time sideline audio allows a user to hear the game day action just as if the user was sitting in the front row or on the field. As many sports fans know, sometimes the best part of the game is trash talking between players, the yelling at the ref, the sound of the bone-crunching hits and the off-the-cuff player outbursts. However, unless you're sitting in the stands, you'll miss all this game audio, as most games are only streamed with the commentators announcing the game. The mobile sports application for game-time sideline audio as claimed lets users watch the game from home and listen to the audio from a live or recorded sports broadcast just as if they were at the game, without the interruption of color commentary, so they can feel like they're in the action, not just watching it.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a mobile sports application for game-time sideline audio, constructed and operative according to the teachings of the present invention.

FIG. 1 shows a workflow diagram illustrating screen flow during use for the sidelines audio app, according to an embodiment of the present invention.

FIG. 2 shows a workflow diagram illustrating a method of use for the sidelines audio app according to an embodiment of the present invention of FIGS. 1-5.

FIG. 3A-G shows perspective view illustrating interactive screens within the app, according to an embodiment of the present invention.

FIG. 4 shows a perspective view illustrating a game in progress, according to an embodiment of the present invention.

FIG. 5 is a flowchart illustrating an example of how the information is transferred between a user's device and one more centralized servers.

The various embodiments of the present invention will hereinafter be described in conjunction with the appended drawings.

### DETAILED DESCRIPTION

As discussed above, embodiments of the present invention relate to a mobile app and more particularly to a mobile sports application for game-time sideline audio, creating a functional tangible use for the end-user.

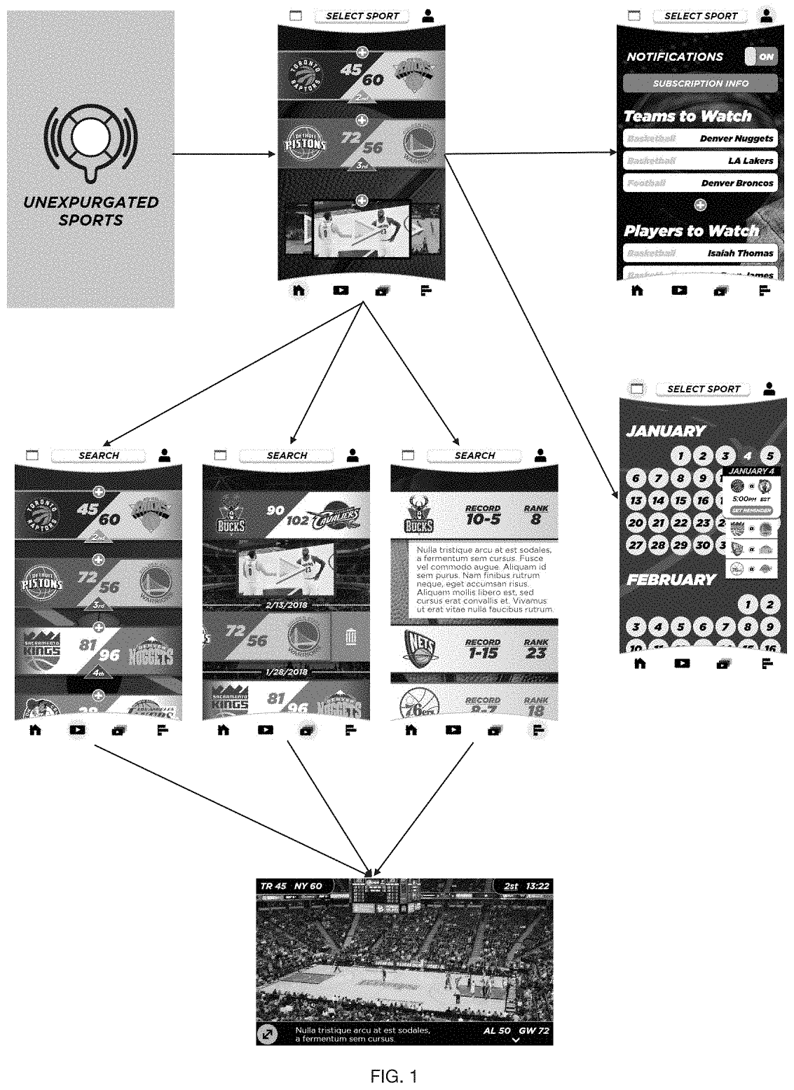

Referring now to the drawings FIGS. 1-5, the mobile sports application for game-time sideline audio allows a user to hear the game day action just as if the user was sitting in the front row or on the field, so they can feel like they're in the action, not just watching it. The app includes easy to use features such as:
Streaming games on a mobile device while hearing all the action as if the user were on the sidelines
Automatically push games and clips from a user's favorite teams to the user's home screen, to get the news each user wants upfront
View clips and highlights of favorite players and teams, then save favorite moments to re-watch later
Easy-to-use search function finds live games, archived games and clips, and specific teams and players
Includes detailed team and player stats
Calendar view puts the whole league's schedule at users' fingertips, with customizable reminders for game dates and start times so users never miss a game
Customizable feeds and a notifications page to keep users up-to-date with their favorite teams and players
Ticker feature shows scores from other live games, with an option to toggle the overlay off for a more immersive viewing experience

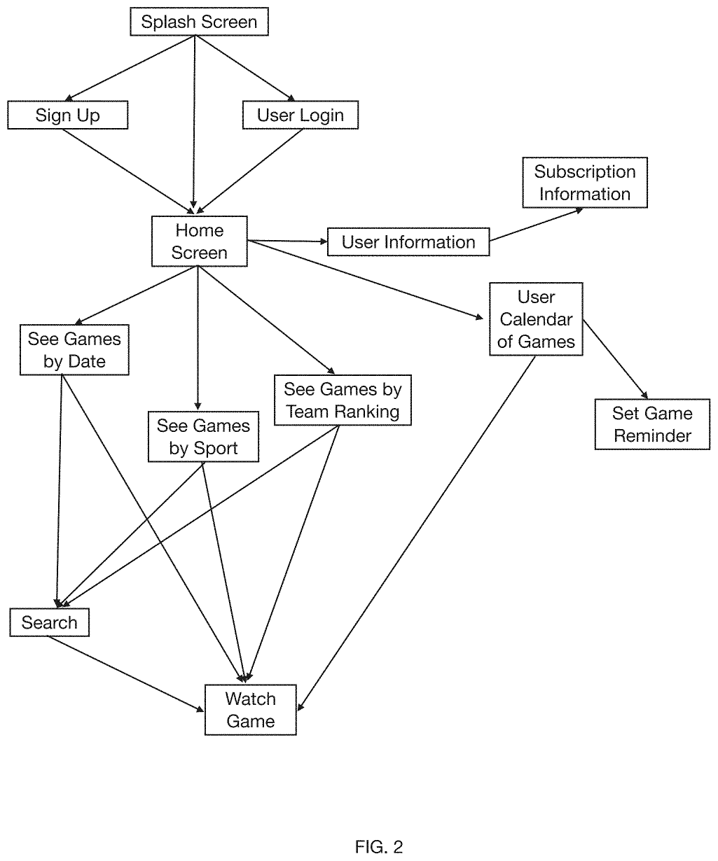

Referring now to FIGS. 1 and 2, a broad work flow chart of the sideline audio app, the general steps in the method used by the sideline audio app are depicted. FIG. 1 illustrates a broad flow chart of screens within the app and how they relate to each other as the user swipes or moves through them. FIG. 2 illustrates a flow chart of the app functions and how they relate to each other.

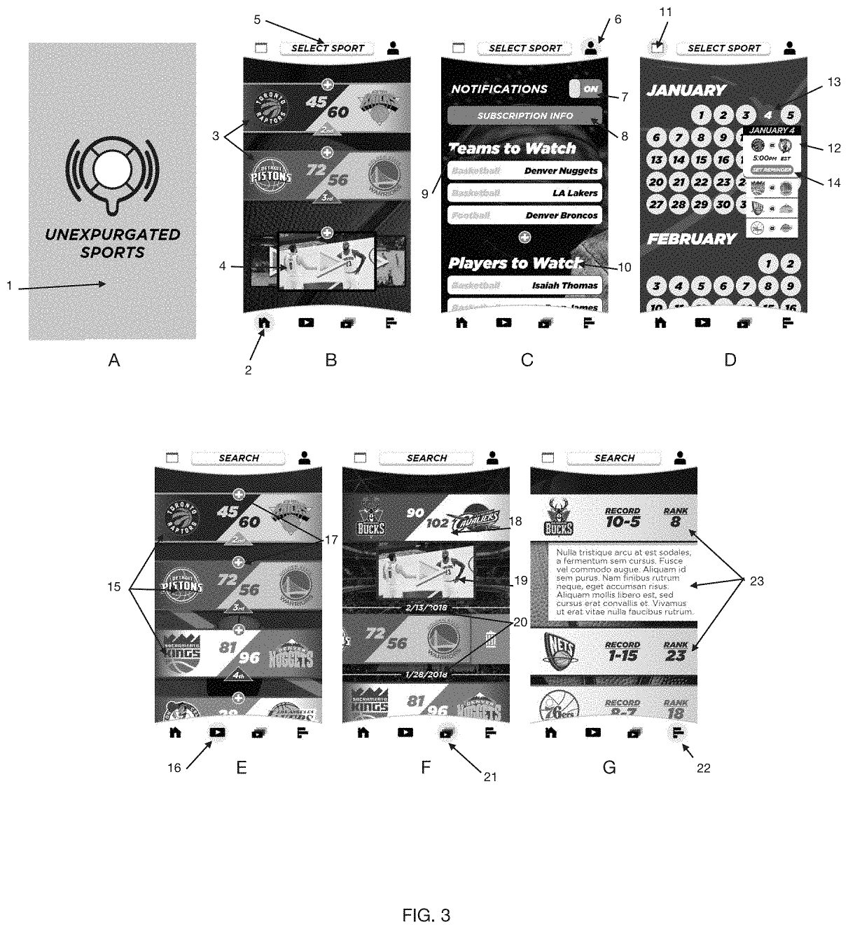

As shown in FIG. 3A, the app beings with splash screen 1. Once the app loads, the splash screen 1 turns into the home screen, an example of which is shown in FIG. 3B. The home screen is indicated by the house button 2 in the lower left corner, and includes additional buttons to access the user's information, an example of which is shown in FIG. 3C, and the calendar view, an example of which is shown in FIG. 3D.

As shown in FIG. 3B, the home screen is a customizable feed that may include information on specific games 3 and clips 4 that the user has indicated are important. The user may also choose to narrow the home page results to a specific sport via the select sport button 5.

As shown in FIG. 3C, the user's information page is accessed by selecting the user button 6, which may be located in the upper right corner of the screen. The user's information page may include a button to toggle on and off notifications 7, a subscription info button 8 that will transfer the user to a page with information regarding their subscription, a list of teams the user is currently keeping track of 9 and a list of players the user is currently keep track of 10.

As shown in FIG. 3D, the calendar view, accessed via a calendar view button 11, which may be located in the upper left corner of the screen. The calendar view page allows a user to see all games on a specific date 12 by clicking on that date 13, and add a reminder about the game via an add reminder button 14 if they so choose.

As shown in FIG. 3E, the video page includes all live and upcoming games 15. The video page is accessed by the video button 16, which may be located along the lower edge of the screen. The live games 15 can be added to the home screen via an add button 17 that pushes the game to the user's customized feed on the home screen. As shown in FIG. 3F, the user can save archived games 18 and clips 19, which can be sorted by date 20 and reviewed by the user whenever they want. The game and clip archive is accessed by the archive button 21, which may be located along the lower edge of the screen.

As shown in FIG. 3G, the app also has a stats page, which may be accessed by a stats button 22. The stats page keeps track of detailed team and player stats 23 for each team and player the user is following, as shown in the user information page via the user information button 6.

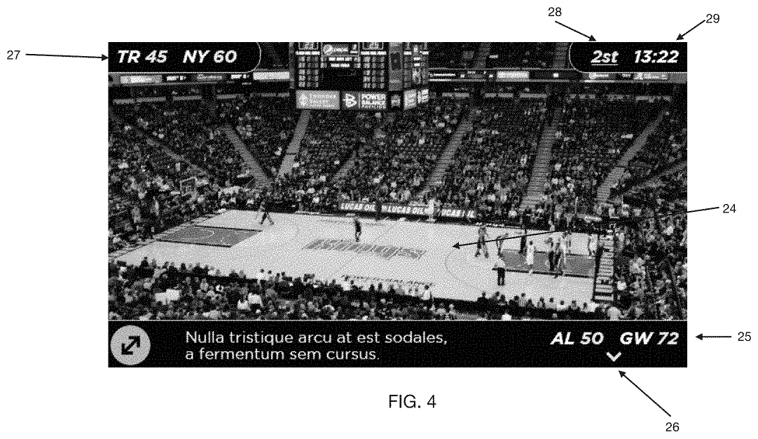

As shown in FIG. 4, an example of the video viewing screen, the video 24 can be viewed in full screen on the user's device. The video-viewing screen also has a ticker feature 25 that shows scores from other live games, with an option to toggle the overlay off 26 for a more immersive viewing experience. The video-viewing screen also displays the score of the game currently being viewed 27, what period the game is currently in 28, and the time left in that period 29.

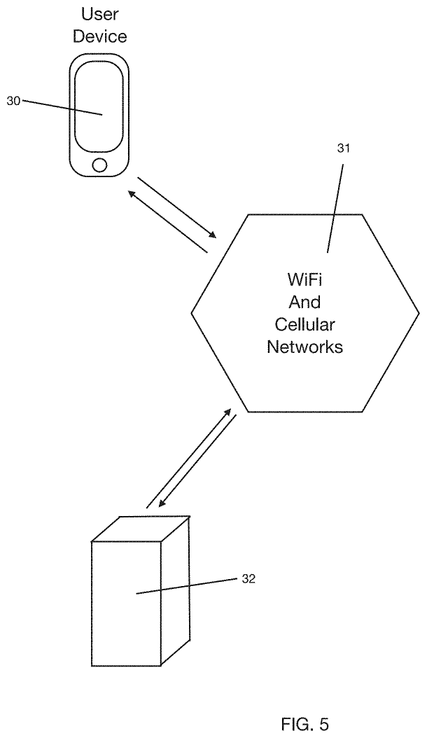

As shown in FIG. 5, the user's information, including login, game and sport searches and queries, saved videos and clips, is collected by the sideline audio app on each user's device 30 as shown in the flow chart in FIGS. 1 and 2. The information is then sent by the user's selected cellular or other wireless network 31 to one or more centralized servers 32. The linking of the video and sideline audio into one watchable video is performed on a middle end component or a back end component or a combination of a middle end component and a back end component 32, as outlined in the flow chart in FIGS. 1 and 2. The resulting videos are sent back to the user's device(s) 30 over the user's network 31, which can be a cellular network, wireless network, and/or the Internet network.

It should be noted that the steps described in the method of use can be carried out in many different orders according to user preference. The use of “step of” should not be interpreted as “step for”, in the claims herein and is not intended to invoke the provisions of 35 U.S.C. § 112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

Additionally, the logic flows depicted in the figures do not require the specific order shown to achieved the desired object. Additional steps may be added, or steps may be removed, from the described flows, and other components added or removed, from the described systems, creating different implementations that are within the scope of the following claims.

What is claimed is new and desired to be protected by Letters Patent is set forth in the appended claim:

1. A method performed by one or more processing devices, the method comprising the steps of:
(a) displaying a graphical interface to a user via a first processing device;
(b) requesting personal information from the user via the graphical interface;
(c) in response to the request, receiving the requested personal information from the user via a network connection between the first processing device and one or more storage devices;
(d) storing the received personal information on the one or more storage devices;
(e) displaying information on available live or archived sports games and clips to the user via the first processing device;
(f) receiving requests from the user regarding desired live or archived sports game or clip via the graphical interface;
(g) storing the received request on the one or more storage devices;
(h) ensuring the requested live or archived sports game or clip is linked to a corresponding sideline audio file; and
(i) displaying the requested live or archived sports game or clip with the corresponding sideline audio file on the first processing device via the graphical interface.

2. The method according to claim 1, the method comprising the further steps of:
(j) Requesting personalization information from the user via the graphical interface regarding favored teams and players;
(k) in response to the request, receiving the requested personalization information from the user via the network connection between the first processing device and the storage device;
(l) storing the personalization information on the storage device;
(m) customizing a feed on the user's according the received personalization information; and
(n) displaying the feed to the user via the graphical interface on the first processing device.

3. The method according to claim 2, the method comprising the further steps of:
(o) Calculating statistics regarding team and player performance;
(p) storing the calculated statistics on the storage device; and
(q) displaying the calculated statistics via the graphical interface of the first processing device for any teams and players included in the personalization information.

4. The method according to claim 2, the method comprising the further steps of:
(o) displaying a calendar on the graphical interface of the first processing device;
(p) receiving a selected date from the user via the graphical interface on the first processing device;
(q) displaying information regarding all games available on the user's selected date via the graphical interface of the first processing device.

5. The method according to claim 1, the method comprising the additional step of:
(r) providing a login process, whereby the user can access the user's account stored information on a second processing device without having to re-enter all the information.

6. An assembly including a first storage device connected via a network to one or more second storage devices storing instructions that are executable to perform operations, the operations comprising:
(a) displaying a graphical interface to a user on the first storage device;
(b) requesting user and personalization information from the user via the first graphical interface;
(c) storing the received user and personalization information on the first storage device or one or more second storage devices;
(d) receiving game and clip requests from the user via the graphical interface of the first storage device;
(e) storing sports games and clips and sideline audio files on the one or more second storage devices;
(f) displaying requested sports games and clips with an associated sideline audio file on the graphical interface of the first storage device;
(g) displaying a list of saved sports games and clips on the graphical interface of the first storage device;
(h) calculating, or storing, or calculating and storing statistics on individual sports teams and players on the one or more second storage devices;
(i) displaying the statistics on individual sports teams and players on the graphical interface of the first storage device;
(j) displaying an interactive calendar on the graphical interface of the first storage device, wherein all sports games available on a date are likewise displayed with the date is selected by the user on the interactive calendar; and
(k) customizing a feed for each user using the personalization information and displaying the feed on the graphical interface of the first storage device.
